(19) United States
(12) Patent Application Publication
(10) Pub. No.: US 2002/0078944 A1
(43) Pub. Date: Jun. 27, 2002

(54) Quick assembly barbecue grill

(76) Inventors: Steven Cozzolino, Oakland, CA (US); Philip Edwin Hague, Chicago, IL (US); Michael S. Joss, Chicago, IL (US); Jeffery Scott Kunkler, Los Angeles, CA (US); John Van Akkeren, Chicago, IL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/927,203

(22) Filed: Aug. 10, 2001

Related U.S. Application Data
(60) Provisional application No. 60/224,620, filed on Aug. 11, 2000.

(51) Int. Cl. A47J 37/00

(52) U.S. Cl. 126/41 R; 126/50; 126/305

(57) ABSTRACT

A quick assembly barbecue grill comprising a grill casting and a plurality of legs pivotally mounted to the grill casting. The legs are configured to pivot about said grill casting between a retracted position and an extended position.

### CROSS-REFERENCE TO RELATED APPLICATION

This application claims priority to copending U.S. provisional application entitled, “Quick Assembly Barbecue Grill,” having Ser. No. 60/224,620, filed Aug,11, 2000, which is entirely incorporated herein by reference.

### FIELD OF THE INVENTION

This invention relates generally to the field of barbecue cart assemblies and barbecue grills and, more particularly, to quickly assembled barbecue cart assemblies with grills mounted thereon, and having a storage configuration.

### BACKGROUND OF THE INVENTION

It is common for barbecue grills and especially gas barbecue grills to be situated on a movable cart. Such carts, in general have the grill located centrally on the top of the cart, and may include a plurality of side shelves close to the level of the cooking surface. Many carts also include wheels for ease in moving the cart around. The cart is normally designed so as to elevate the cooking surface of the grill and the side shelves to approximately the waist level of an adult for ease and comfort of use of the grill.

A barbecue grill and cart assembly typically stands several feet high and is often rather wide with side burners and shelves. Consequently, a merchant displaying each barbecue grill and cart assembly requires a large amount of retail floor or shelf space. Maintaining a reasonable sized inventory can also consume a large amount of retail space. However, retail space is a very valuable commodity and retailers prefer compact packaging of products in order to maximize their available space. Shipping such large sized items can also be costly. Normally a barbecue grill and cart assembly is shipped from the manufacturer to retail outlets unassembled, in order to minimize the size of the shipping container, and to allow the retail outlets to stock more product. As a consequence, the grill and cart assembly must be assembled prior to use. Typically, the retailers offer to assemble the barbecue grill and cart assembly for the end user for a nominal fee or perhaps even for free. Thus, assembling a barbecue grill and cart is typically a money loser for the retailer once the labor cost exceeds the fee charged for assembly. Included in the labor cost is the time required to train an employee to assemble a barbecue grill and cart assembly, and the more complex the assembly is, the longer it takes to train the employee to assemble the product. Therefore, there exists a need for a barbecue grill and cart assembly that can be shipped unassembled and quickly and easily assembled so as to minimize the labor cost related to the assembly. The potential retail demand for a quickly assembled barbecue grill and cart assembly is substantial.

In addition, some end users prefer to assemble the barbecue grill and cart assembly themselves, so as to avoid paying the retailer to assemble it. Other end users may desire to assemble the barbecue grill and cart assembly themselves because they do not have the means to transport an assembled unit. However, if a barbecue grill and cart assembly is too complicated to be easily assembled by the end user, because it has many separate components and/or it requires special tools to assemble, then the end user may refrain from purchasing it. Also, a complex assembly can result in a frustrated customer resulting in a loss of repeat business for the manufacturer. Once purchased by a consumer, barbecue grills typically remain assembled and are stored either in a garage or storage area, where space is generally limited. Therefore, there exist a need for a barbecue grill and cart assembly that can be easily transported from a retail location to an end use location, and can be easily assembled by an untrained end user, yet which otherwise has a compact storage configuration.

### SUMMARY OF THE INVENTION

The present invention is a quick assembly barbecue grill comprising a grill casting and a plurality of legs pivotally mounted to the grill casting. The legs are configured to pivot about said grill casting between a retracted position and an extended position. Front and rear legs on each side of the grill casting are joined together in spaced relationship to form a yoke which is pivoted to the underside of the bottom portion of the grill. Each yoke may be swung in an arc from the extended or operative position to the retracted position or storage position.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of the quick assembly barbecue grill of the present invention with the legs in the extended position.

FIG. 2 is an exploded perspective view of the quick assembly barbecue grill of FIG. 1.

FIG. 3 is a perspective view of the quick assembly barbecue grill of FIG. 1 with the legs in the retracted position.

FIG. 4 is a cross sectional view of an upper leg connecting strut coupled to a firebox of the quick assembly barbecue grill of FIG. 1.

FIG. 5 is a side view of a basket attached to the front legs of the quick assembly barbecue grill of FIG. 1.

FIG. 6 is a partial side view of a lower leg connecting strut of the quick assembly barbecue of FIG. 1 and an LP tank.

FIG. 7 is a partial exploded view of an alternate embodiment of the present invention.

### DETAILED DESCRIPTION OF THE INVENTION

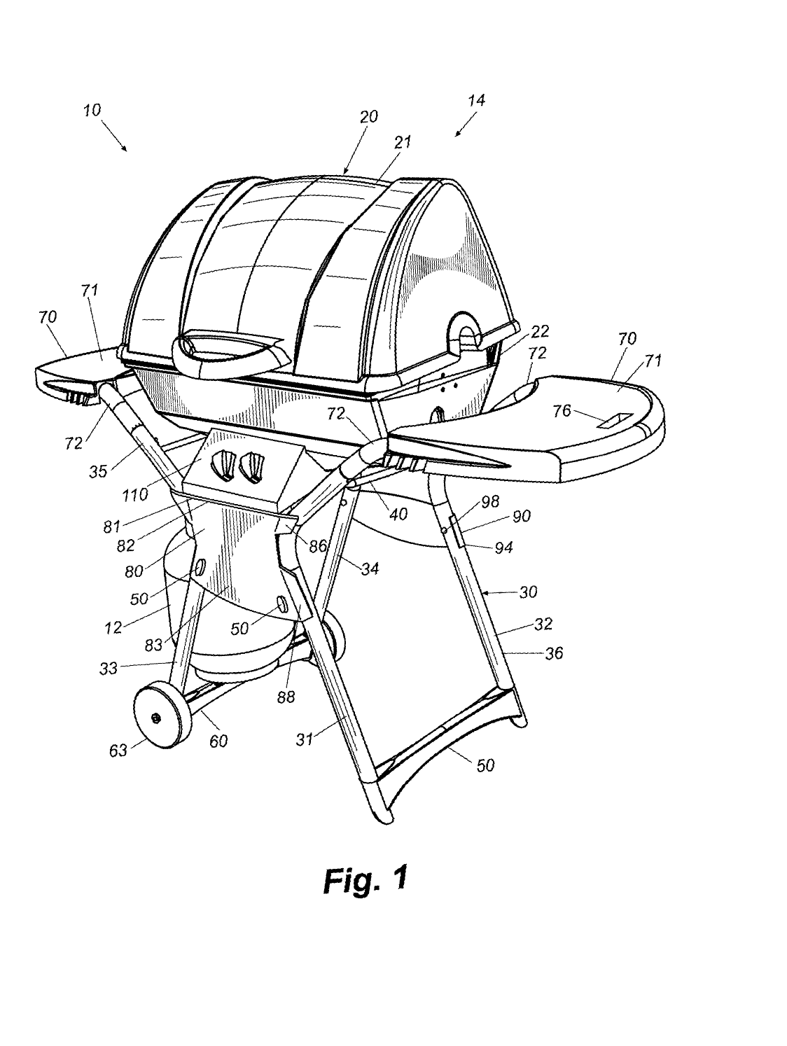

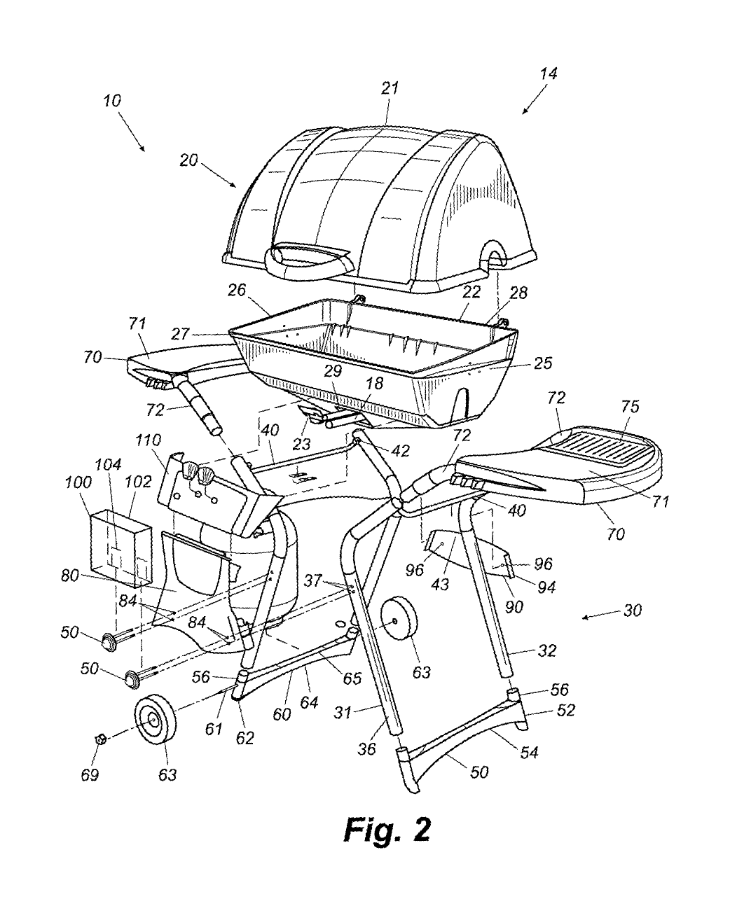

As described herein, embodiments of the quick assembly barbecue cart assembly and grill are adapted for the heating and cooking of various foods. Referring now more specifically to the drawings, and to FIGS. 1 and 2 in particular, numeral 10 designates generally the quick assembly barbecue grill of the present invention. LP tank 12 is typically a standard LP tank used in a conventional gas barbecue grill. The structural members of the cart are preferably fabricated from steel, aluminum, etc., but may be provided from any other suitable material providing the necessary strength and resistance to heat is present.

The present quick assembly barbecue cart assembly with grill 10 includes a gas grill 14 and a cart assembly 30. The gas grill 14 includes a grill casting 20 having a hood 21 and a firebox 22, venturi tubes 18 and gas control valves 23 comprising the gas train. The firebox 22 and hood 21 together define grill casting 20 having a right side 25, a left side 26, a front side 27 and a rear side 28. The hood 21 is configured to be removably coupled to firebox 22 at rear side 28 by suitable hinges. Firebox 22 is a conventional firebox having an essentially hollow interior adapted to receive a gas burner assembly, not shown, with a venturi tube aperture 29 formed in front side 27. Thus, venturi tubes 18 extend from the gas burner or burners through aperture 29 in the front side 27 to control valves 23.

The cart assembly 30 includes a front plate 80, a rear face plate 90, a plurality of upper leg connecting struts 40, and a plurality of tubular legs: right front leg 31, right rear leg 32, left front leg 33, and left rear leg 34. Each leg comprises a generally reclined L-shape having an upper portion 35 and a lower portion 36.

Typically, upper leg connecting strut 40, having opposed ends 42, is formed from a piece of steel rod, tubing, or the like. Opposed ends 42 are aligned and bent approximately perpendicular to the longitudinal length of the rod. Upper leg connecting strut 40 is for rigidly connecting a pair of legs together proximal to the end of upper portion 35. Typically, each opposed end 42 is rigidly affixed to an upper portion 35 of a leg by means such as welding. Thus, a pair of legs coupled together by a connecting strut 40 essentially forms a single element or yoke that pivots as one.

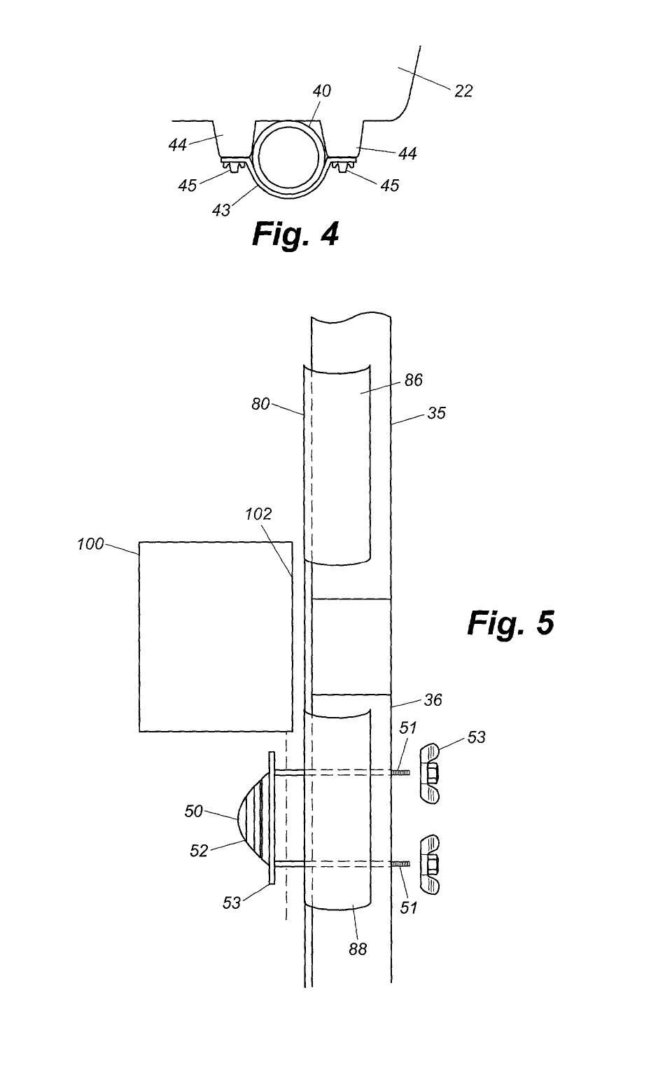

Connecting strut 40 is pivotally mounted to the underside of and proximal to right side 25 of firebox 22 and an opposing connecting strut 40 is pivotally mounted to the underside of and proximal to left side 26 of firebox 22. Each upper leg connecting strut 40 is pivotally mounted to the firebox 22 by a conventional means known to those skilled in the art including, but not limited to, press fitting bracket 43 to firebox 22, bolting bracket 43 to firebox 22, etc., as shown in FIG. 4. The connecting struts 40 are configured to extend between front side 27 and rear side 28 of grill casing 20. Thus, right side pair of legs 31 and 32 and left side pair of legs 33 and 34 are formed into yokes which are configured to pivot about the grill casing 20.

FIG. 4 illustrates one embodiment for fixing the upper leg connecting strut 40 in position for use of the barbecue cart assembly with grill 10. Firebox 22 comprises a plurality of protrusions 44 extending generally downward and configured to receive a portion of upper leg connecting strut 40 shown as a tube in FIG. 4. Upper leg connecting strut 40 is held in place between protrusions 44 by bracket 43. Bracket 43 is press fit onto bosses 45, each boss 45 extending downwardly from protrusion 44. In another embodiment, bracket 43 holds upper leg connecting strut 40 in position against firebox 22 by engaging a plurality of externally threaded bolts extending downwardly from firebox 22 with a plurality of internally threaded nuts. In another embodiment, strut 40 is a straight axle extending through bores formed in front side 27 and rear side 28 of firebox 22.

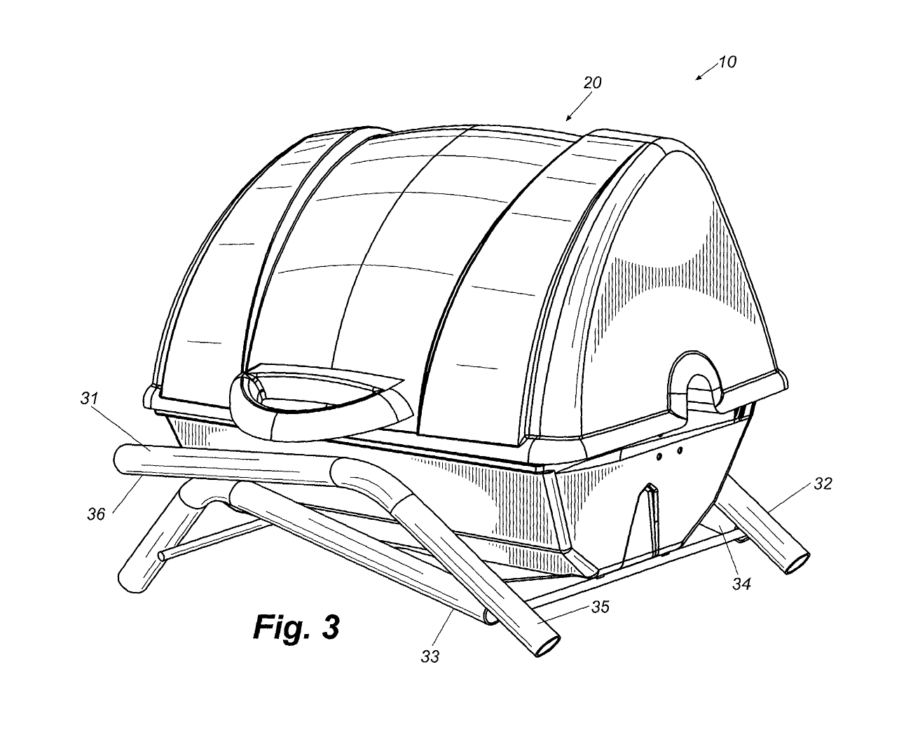

Referring now to FIG. 3, the quick assembly barbecue grill assembly with grill 10 is generally shipped from the manufacturer with right front leg 31 and with left front leg 33 substantially adjacent each other and nested along front side 27 of grill casting 20, and right rear leg 32 and left rear leg 34 nested along rear side 28 of grill casting 20 having been folded in the direction of the arrows in FIG. 2. To assemble the quick assembly barbecue grill assembly with grill 10, the yoke formed by right side legs 31 and 32 is pivoted over the top of the grill casting 20 such that the bottom portion 36 of each leg 31 and 32 extends generally downward, and the yoke of left side legs 33 and 34 is also pivoted such that the bottom portion 36 of each leg 33 and 34 extends generally downward. Each pair of legs, right side pair 31 and 32, and left side pair 33 and 34, pivot essentially as one element, or yoke. The yokes are unfolded in the direction opposite to the arrows in FIG. 2

Turning again back to FIGS. 1 and 2, the right side legs 31 and 32 are coupled to the left side pair of legs 33 and 34 to lock the pairs of pivotal legs in operable position. Rear legs 32 and 34 are coupled by rear face plate 90, and front legs 31 and 32 are coupled together by front face plate 80. Rear face plate 90 is generally formed from a piece of rigid plastic or sheet metal, and is coupled to rear legs 32 and 34 by conventional means. Rear legs 32 and 34 have bores (not shown) formed therethrough for receiving bolts (not shown). Rear face plate 90 has bores 96 formed therethrough for receiving bolts (not shown). Rear face plate 90 is positioned against rear legs 32 and 34 with rear leg bores (not shown) aligned with bores 96 and fastened together, such as by externally threaded bolts (not shown) in combination with internally threaded nuts 98, or the like. Thus, rear legs 32 and 34 are rigidly coupled together. Rear face plate 90 further includes opposed side walls 94 extending partially around rear legs 32 and 34 when rear face plate 90 is coupled thereto.

Front face plate 80 is generally formed from a piece of rigid plastic and is adapted to be coupled to the two front legs 31 and 33. Front base plate 80 includes a top end 81 having opposed upper side walls 86 and groove 82 formed therein and a bottom end 83 having opposed bottom side walls 88. Groove 82 is for receiving a lip of the control panel (described in detail hereinbelow). Opposed upper side walls 86 are configured to extend partially around upper portion 35 of legs 31 and 33 when front face plate 80 is coupled to front legs 31 and 33 as best seen in FIG. 5. Similarly, opposed bottom side walls 88 are configured to extend partially around bottom portion 36 of legs 31 and 33 when front face plate 80 is coupled to front leg 31 and 33. Opposed bottom side walls 88 and opposed upper side walls 86 are angled inward to conform to the generally reclined L-shape of legs 31 and 33.

Front face plate 80 further includes a plurality of pairs of bores 84. Each pair of bores 84 is adapted to receive a substantially U-shaped bolt 51. Each front leg 31 and 33 includes a pair of bores 37 for receiving a generally U-shaped bolt 51, or any suitable means. Front face plate 80 is positioned against front legs 31 and 33 with opposed upper side walls 86 extending partially around upper portion 35 of legs 31 and 33, opposed side walls 88 extending partially around bottom portion 36, and with U-bolt receiving bores 37 and 84 aligned.

The cart assembly 30 further includes a first lower leg connecting strut 50 for connecting the bottom portion of the right side pair of legs 31 and 33, and a second lower leg connecting strut 60 for connecting the bottom portion of the left side pair of legs 32 and 34. The first lower leg connecting strut 50 includes opposed ends 52 and arm 54 extending therebetween. Each opposed end 52 comprises a stub 56 extending generally upward therefrom. First lower leg connecting strut 50 is press fit with right side legs 31 and 32 such that a stub extending from each opposed end 52 is snugly received by the bottom portion 36 of right side legs 31 and 32. Thus, lower leg connecting strut 50 rigidly connects the bottom portions 36 of right side legs 31 and 32.

The second lower leg connecting strut 60 includes opposed ends 62 having arm 64 extending therebetween. Each opposed end 62 comprises a stub 56 extending generally upward therefrom. Second lower leg connecting strut 60 is configured to be press fit with left side legs 33 and 34 such that a stub 56 extending from each opposed end 62 is received by bottom portion 36 of left side legs 33 and 34, respectively. Thus, lower leg connecting strut 60 rigidly connects the bottom portions 36 of left side legs 33 and 34.

In reference to FIG. 1, cart base 30 forms a rigid stable structure. Each of the legs 31, 32, 33, and 34 are directly connected to three structural elements, and indirectly connected to two other legs. For example, right front leg 31 is directly coupled to front faceplate 80, lower leg connecting strut 50, and upper leg connecting strut 40, and is indirectly connected to left front leg 33, through front plate 80, and right rear leg 32, through lower leg connecting strut 50 and upper leg connecting strut 40. Thus, even though cart base assembly 30 is rapidly and quickly assembled using very few fasteners, the cart base assembly 30 is very rigid and stable because the structural elements are coupled together.

Referring to FIGS. 1 and 2, barbecue grill cart assembly with grill 10 further includes a control panel 110 adapted to receive gas control valves 23. Control panel 110 has lip 102 extending generally downwardly therefrom. Lip 102 is received by groove 82 of front face plate 80.

Cart base 30 further includes at least one side shelf 70, but preferably a plurality of side shelves 70. Each side shelf 70 includes a flat plate 71, and a pair of arms 72 extending beneath flat plate 71. Each pair of arms 72 is adapted to plug into the upper ends of either the right end pair of legs or the left end pair of legs. In one embodiment, at least one side shelf includes a burner 75. In another embodiment, flat plate 71 of at least one side shelf includes an aperture 76 formed therethrough adapted to receive a hand of a user. Aperture 76 forms a hand hold for the user to grip the handle for moving barbecue grill cart assembly with grill 10.

Referring to FIGS. 1 and 5, each U-shaped bolt 51 has a pair of threaded bolts extending from head 52. Head 52 has flange 53 extending therefrom. U-shaped bolt 51 extends through bores 84 of front face plate 80 and through bores 37 formed in bottom portion 36 of right front leg 31. Bolts 51 are externally threaded and engage internally threaded wing nuts 53. Basket 100 has slots 104 formed in rear wall 102. Each slot 104 is adapted to receive head 52, and flange 53 presses rear wall 102 against front face plate 80 when wing nuts 53 are tightened on bolts 51.

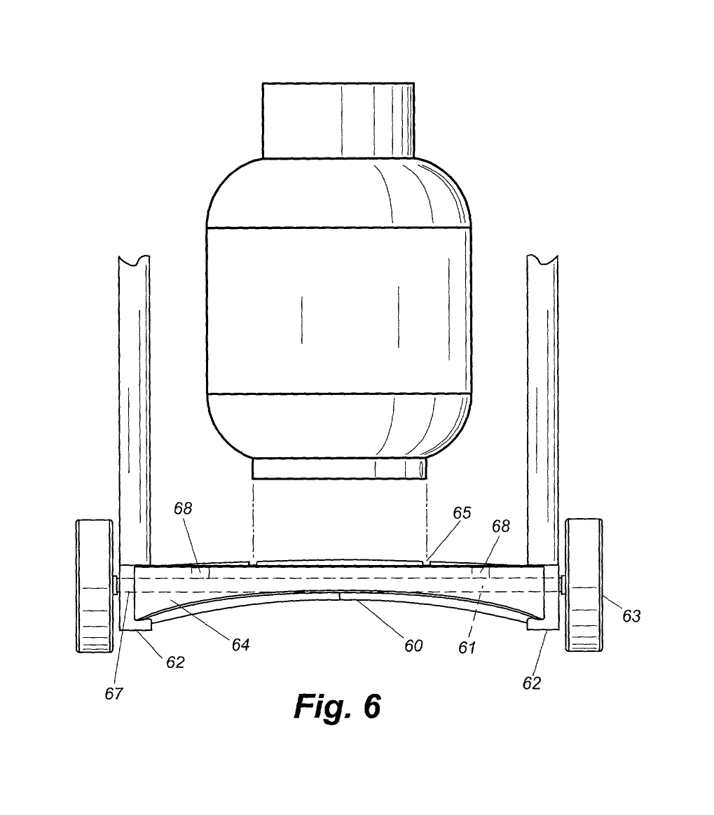

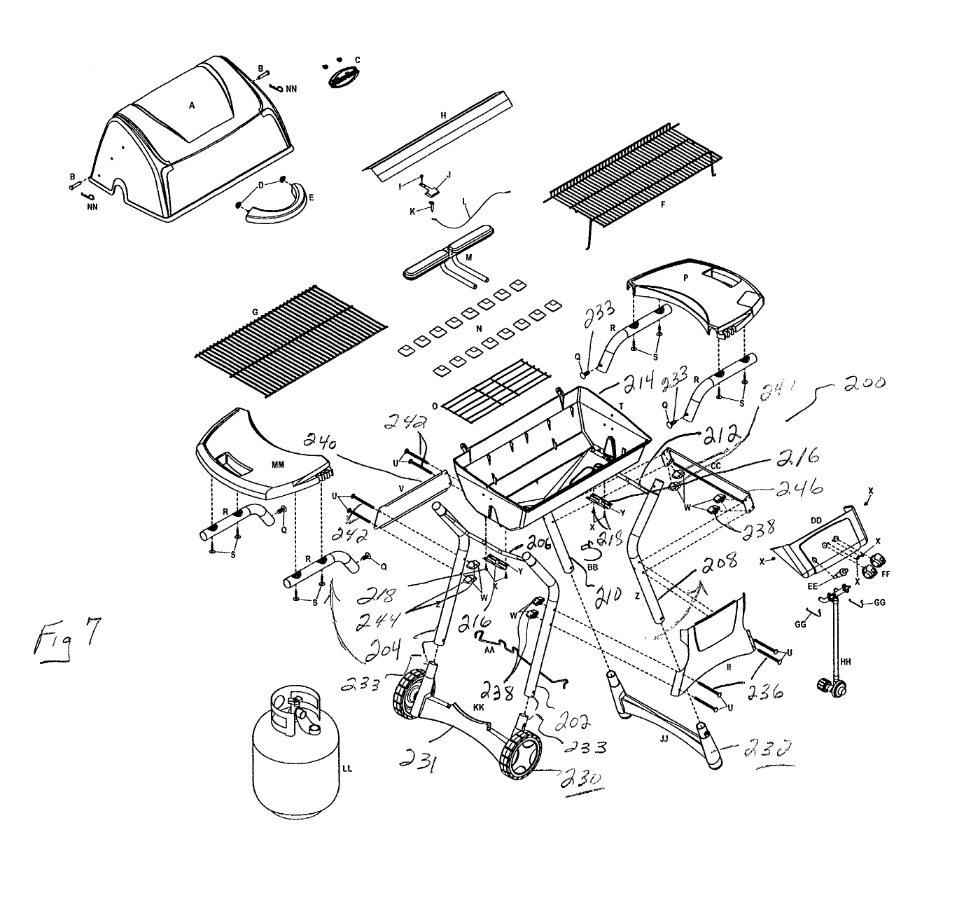

As illustrated in FIG. 6, second lower leg connecting strut 60 further includes means for receiving and supporting LP tank 12 and conventional rolling means. Strut 60 comprises wheels 63 rotatably coupled thereto to facilitate rolling the barbecue grill and cart assembly 10. Strut 60 includes bore 67 extending between opposed ends 62 and axle 61 extending therethrough with wheels 63 pivotally mounted thereon. Each wheel 63 is maintained in proper position in a conventional manner, such as inserting a cotter pin (not shown) through a transverse bore (not shown) which is formed through the distal end of axle 61, by engaging an externally threaded distal end of the axle 61 with an internally threaded nut 69, by press fitting, or any suitable means as is well known in the art.

Arm 64 of second lower leg connecting strut 60 has notches 65 formed therein for receiving LP tank 12. Struts having notches formed therein for receiving a LP tank are well known to those skilled in the art. For example, U.S. Pat. No. 5,931,149, incorporated herein by reference, teaches a pivotally mounted strut having notches for receiving a LP tank. Arm 64 further includes a plurality of tabs 68 extending generally downward. Tabs 68 engage axle 61 when LP tank 12 is received by notches 65. Thus, the weight of LP tank 12 is supported on the axle 61. Without tabs 68, arm 64 could bow under the weight of LP tank 12. As a consequence of the bowing of arm 64, notches 65 pinch LP tank 12, thereby making it difficult to remove the tank. Thus, tabs 68 support arm 64 on axle 61 so that notches 65 do not pinch LP tank 12, thereby making it easy for the user to remove the tank from connecting strut 60 for refilling, replacement, etc.

An alternate embodiment of the present invention is shown in FIG. 7. In this embodiment, the basic design is the same, but with the noted exceptions and modifications to the construction of the cart 200. As viewed from the front, left front leg 202 and left rear leg 204 are connected by a transverse strut 206. Similarly, right front leg 208 and right rear leg 210 are connected by a transverse strut 212. Struts 206 and 212 are configured to generally conform to the bottom of the lower grill casting or firebox 214.

These struts are connected to the firebox using casting seat brackets 216 which are slightly elongated and which extend and are disposed parallel to the struts 206 and 212. Suitable fasteners, such as screws 218 are disposed through the casting seat brackets and into the bottom of the firebox. This fastens the leg assemblies to the firebox while allowing the leg assemblies or yokes to rotate in the brackets upwardly in the direction of the arrows to the position shown in FIG. 3 for transport, shipping or storage of the unit. As described hereinabove, the leg assemblies are secured at the place of manufacture so the consumer need only pivot the legs to their operative position prior to use

With the legs in operative position, the wheel assembly 230 and feet 232 are telescopically mounted to the bottom of the left and right leg assemblies, respectively. Suitable fasteners such as screws or pins 233 are used to secure the lower wheel and feet assemblies to the legs. Front panel 234 spans the left and right leg assemblies in the front of the grill cart and is secured thereto with suitable fasteners, preferably screws 236 and wing nuts 238. A rear panel 240 spans the left and right leg assemblies in the rear of the cart and is also secured with suitable fasteners such as screws 242 and wing nuts 244. Feet 232 function to support and stabilize the assembly in the desired location to which it was moved by means of the wheel assembly 230. The wheel assembly 230 includes an LP gas tank mounting strut 231 for receiving an LP tank.

A side brace 246 is added in this embodiment on the right side of the cart and spans the right front and rear legs at the appropriate midpoint thereof. The side brace is normally connected at the connection points of the front and rear panels using the same fasteners, screws 236 and wing nuts 238 in the front leg and screws 242 and wing nuts 244 in the rear leg. The side brace thus interconnects the front and rear panels, thereby providing an extremely stable cart assembly.

The side shelf assemblies are telescopically joined to the upper portions of the leg assemblies and held in place with fasteners such as pins 233, similar to the wheel and feet assemblies.

Although a preferred embodiment of the invention has been disclosed in detail herein, it will be obvious to those skilled in the art that variations and modifications of the disclosed embodiment can be made without departing from the spirit and scope of the invention as set forth in the following claims.

We claim:

1. A barbecue grill assembly comprising:
a grill casting having first and second ends; and
a plurality of legs pivotally mounted to said grill casting, wherein said legs are configured to pivot about said grill casting through an arc between a storage position and an operative position.

2. The barbecue grill assembly of claim 1, wherein the legs of each pair of said plurality of legs are joined to form a pivotable yoke.

3. The barbecue grill assembly of claim 2, wherein each of said yokes is configured to nest along side said grill casting.

4. The barbecue grill assembly of claim 2, wherein one pair of legs is pivotally mounted proximate said first end of said grill casting and the other pair of legs is pivotally mounted proximate said second end of said casting.

5. The barbecue grill assembly of claim 4 further including:
a faceplate for coupling to one leg of said first pair of legs and to a corresponding leg of said second pair of legs;
said faceplate being mountable to said first and second pair of legs, and wherein when said first pair of legs and said second pair of legs extend generally downward with said faceplate coupled therebetween and said first and second pair of legs are held substantially rigidly in operable position, said legs having bottom ends.

6. The barbecue grill assembly of claim 5 further including a connecting strut having opposed ends and an arm extending therebetween, said ends being mountable to said bottom ends of said first pair of legs.

7. The barbecue grill assembly of claim 6 further including:
an axle having opposed ends extending through said connecting strut; and
a pair of wheels mounted to said opposed ends of said axle.

8. The barbecue grill assembly of claim 7, wherein said arm of said connecting strut is adapted to receive a portion of a LP tank.

9. The barbecue grill assembly of claim 5 further including a second connecting strut having opposed ends and an arm extending therebetween, said ends of said second connecting strut being mountable to said bottom ends of said second pair of legs.

10. The barbecue grill assembly of claim 5 further including a side tray comprising a generally flat plate mountable to one of said pairs of legs.

11. The barbecue grill assembly of claim 10 further including a second side tray having a generally flat plate mountable to the other of said pairs of legs.

12. The barbecue grill assembly of claim 5, wherein said first pair of legs comprises a front leg proximal to said front side of said grill casting and a rear leg proximal to said rear side of said grill casting, wherein said second pair of legs comprises a front leg proximal to said front side of said grill casting and a rear leg proximal to said rear side of said grill casting, and further including a second faceplate mountable to said rear leg of said first pair of legs and to said rear leg of said second pair of legs.

13. A barbecue grill assembly comprising:
a grill casting having a lower firebox portion and an upper cover portion hingeably connectable thereto forming an enclosure having a front-to-back width, said lower portion having a bottom and first and second ends;
a first pair of legs having a first yoke configuration pivotably mounted to the bottom of said lower portion proximate said first end thereof;
a second pair of legs having a second yoke configuration pivotably mounted to the bottom of said lower portion proximate said second end thereof;
the legs forming each of said yokes being spaced apart a distance greater than the front-to-back width of said enclosure;
said yokes being pivotably relative to said casting through an arc between an operational position wherein said legs are extended and a storage position wherein said legs are folded adjacent the front and back of said casting.

14. A barbecue grill assembly as claimed in claim 13 wherein each of said first and second yokes comprise a front leg and a rear leg, each of said legs having a top end and bottom end; and
a transverse strut jointing the legs of each of said yokes proximate to the top ends thereof.

15. A barbecue grill assembly as claimed in claim 14 wherein each of said struts is pivotably mounted to said bottom of said lower portion of said grill assembly.

16. A barbecue grill assembly as claimed in claim 15 wherein each of said struts is pivotably mounted to said bottom of said lower portion by means of casting seat brackets fastened to the bottom of said lower portion.

17. A barbecue grill assembly as claimed in claim 14 and further including a wheel assembly comprising first and second wheels telescopically mounted to the legs of said first yolk at the bottom ends thereof.

18. A barbecue grill assembly as claimed in claim 17 and further including first and second feet telescopically mountable to the legs of said second yoke at the bottom ends thereof.

19. A barbecue grill assembly as claimed in claim 14 and further comprising a front panel member mountable to the front legs of each of said first and second yokes to extend therebetween.

20. A barbecue grill assembly as claimed in claim 14 and further comprising a rear panel mountable to the rear legs of each of said first and second yolks to extend therebetween.

21. A barbecue grill assembly as claimed in claim 14 and further comprising a side brace mountable to the front and rear legs of a t least one of said yokes to extend therebetween.

22. A barbecue grill assembly as claimed in claim 14 and further comprising at least one side shelf assembly telescopically mountable to the top ends of the legs of one of said yokes.

23. A method of re-configuring a barbecue grill assembly from a storage configuration to an operative configuration wherein the grill assembly is a casting having a lower and an upper portion separable from each other and has first and second pairs of legs forming first and second yokes, each comprising a front leg and a rear leg, each of said yokes being pivotably swingable through an arc from a storage position to an operative position, said method comprising the steps of:
swinging said yokes at the bottom of the legs of one of the yokes;
attaching wheels at the bottom of the legs of one of the yokes;
attaching feet at the bottom of the legs of the other of the yoke; and mounting a front panel to each of the front legs of the yokes to extend therebetween.

24. The method as claimed in claim 23 and further including the step of mounting a rear panel to each of the rear legs of the yokes to extend therebetween.

25. The method as claimed in claim 24 and further including the step of mounting a side brace to the front and rear legs of one of the yokes to extend therebetween.
